(19) United States
(12) Patent Application Publication
(10) Pub. No.: US 2026/0199157 A1
(43) Pub. Date: Jul. 16, 2026

(54) MODULAR POSTURAL SUPPORT AND MEDICAL EQUIPMENT WHEELCHAIR SYSTEM

(71) Applicants: Peter Anaradian, Elkhorn, NE (US); Justin Chandler, St. Johns, FL (US); Shuyong Luo, Handan City, Hebei Province (CN)

(72) Inventors: Susan Gopaul, St. Johns, FL (US); Hashir Ali Hassan, Sargodha (PK); Shuyong Luo, Handan City (CN)

(21) Appl. No.: 19/560,833

(22) Filed: Mar. 9, 2026

Related U.S. Application Data
(63) Continuation of application No. 19/017,776, filed on Jan. 13, 2025.

(51) Int. Cl. A61G 5/08; A61G 12/00; B62B 7/06; B62B 9/10

(52) U.S. Cl. CPC A61G 5/08; A61G 12/008; B62B 7/062; B62B 9/108

(57) ABSTRACT

A mechanical wheelchair serving as a primary mobility device and a mobile medical-support platform is disclosed. The wheelchair features a collapsible, load-bearing frame reinforced by side X-braces and configured to support a modular postural seating system. The seating system interfaces with the frame via a rigid seat arch that acts as a transverse load-bearing beam, transmitting occupant weight directly into the structural frame members. A latching hook coupled to the seat secures the arch to prevent displacement, while a controlled recline mechanism maintains this structural engagement during angular adjustment. The frame further integrates a plurality of clinical support interfaces, including a height-adjustable infusion pole, a medical equipment holder for oxygen or monitoring devices, and a user access gate within the side frame wall that opens to facilitate lateral patient transfer. The system provides a unified, stable architecture for simultaneous patient mobility and life-support equipment transport.

### CROSS-REFERENCE TO RELATED APPLICATIONS

This application is a continuation-in-part of U.S. patent application Ser. No. 19/017,776, filed on Jan. 13, 2025, which claims priority to Chinese Patent Application No. 202421835943.1, filed on Jul. 31, 2024. This application also claims priority to Chinese Patent Application No. 202020458582.9, filed on Apr. 1, 2020, and published as CN212166099U. The entire contents of these applications are incorporated herein by reference.

### CROSS-REFERENCE TO RELATED APPLICATIONS

The present disclosure relates to the technical field of primary mobility devices, specifically to a mechanical wheelchair for individuals with mobility impairment. More particularly, it relates to an integrated system featuring modular postural support seating and a structural clinical platform for life-sustaining medical equipment.

### BACKGROUND

Conventional primary mobility devices in pediatric and therapeutic environments are often categorized simply as medical carts or transport trolleys. These designs typically prioritize basic mobility but provide limited structural integration between the seating system and the underlying frame. Existing art often treats the seat as a passive component mounted on a frame without a defined load-bearing interface capable of transferring occupant loads in a stable, controlled manner.

While some recent improvements have introduced detachable seats such as those utilizing “hanging” structures this designs frequently suffer from a reduction in stability and safety when carrying significant weight. Furthermore, integrated structural designs often raise the user's center of gravity, which is detrimental to the overall stability of the mobility device.

Legally and functionally, many existing systems represent a “piecemeal” assembly where the seat, frame, and recline mechanisms are treated as separate, unrelated parts, allowing relative movement between components that compromises postural alignment for pediatric users, prevents continuous load transfer during recline adjustment, and creates design-around risks because the mechanical interface is not a defined structural system.

Many patients with mobility impairments require the simultaneous transport of life-sustaining medical equipment, such as oxygen cylinders, infusion systems, respiratory devices, medical pumps, and physiological monitors. Traditional wheelchairs and carts are often single-function devices; they are not structurally designed as integrated medical-support platforms. Consequently, caregivers must often rely on unstable external add-ons that increase the device's footprint and the overall caregiver burden. Additionally, traditional frame designs often lack integrated means for lateral patient transfer, forcing caregivers to lift patients over high frame walls or obstacles, which increases the risk of injury during entry or exit.

Accordingly, there exists a specific clinical and mechanical need for a primary mobility device specifically a mechanical wheelchair that defines a structural seat-to-frame interface utilizing a rigid seat arch and latching system to ensure load transfer, provides modular docking for interchangeable adaptive postural seating systems, maintains continuous load transfer and stable alignment during controlled recline, incorporates an integrated user access gate for safe lateral transfer, and operates as a comprehensive mobile medical-support platform with integrated mounting interfaces for a variety of life-sustaining equipment.

### SUMMARY

The present invention provides a mechanical wheelchair designed for manual or caregiver-assisted primary mobility for individuals with mobility impairment. The device is characterized by a high-strength, collapsible, load-bearing frame reinforced by opposed side X-braces that facilitate a stable transition between a folded storage configuration and an unfolded use configuration.

In an embodiment, a postural support seating system, which is designed to function as a unified structural unit. This system includes a modular seat-to-frame interface where the seating system is secured to the collapsible frame via a defined interface comprising a rigid seat arch (transverse structural beam) and a latching hook mechanism. The rigid seat arch serves as a load-bearing member that transmits occupant load directly into the frame's support members during both static use and dynamic mobility. The latching hook mechanism allows the postural seat to be attached or removed as a modular unit without tools while preventing vertical, lateral, or rotational displacement when docked. Furthermore, the seating shell is contoured with integrated rigid lateral trunk supports configured as structural load-bearing elements to resist lateral trunk collapse during recline and transport.

To meet clinical therapeutic needs, the invention incorporates a controlled recline mechanism that permits caregiver-adjustable angular positioning. The mechanism utilizes a joint bar with an arc-shaped sliding slot and a sliding rod to guide the rotational path of the seat, maintaining continuous structural engagement with the seat arch throughout adjustment to ensure positional stability and uninterrupted load transfer during recline.

Beyond mobility, the frame is specifically configured to serve as a mobile medical-support platform. The frame integrates a plurality of clinical support interfaces to accommodate life-sustaining equipment, including at least one medical equipment holder or mounting interface configured to support an oxygen cylinder, respiratory equipment, a medical pump, or a physiological monitoring device. The platform further comprises a height-adjustable infusion pole assembly to facilitate intravenous therapy during transport. It further includes a vertically aligned multi-tier storage rack to support medical supplies while maintaining a compact lateral footprint.

In an embodiment, the invention provides a modular postural seating system configured for selective attachment to a wheelchair frame. This seating system comprises a rigid postural seat with a backrest and seat pan, a rigid seat arch defining the interface, and at least one latching hook to structurally secure the seat to the wheelchair frame. The system is engineered as a self-contained therapeutic module transferable between compatible wheelchair platforms.

In an embodiment, the invention provides a mobile medical-support wheelchair platform specifically configured to simultaneously provide patient mobility and integrated support for life-sustaining medical equipment during transport. The platform features a plurality of integrated medical equipment support interfaces distributed across structural support members, comprising at least one of an oxygen cylinder holder, an infusion support structure, a respiratory equipment mounting bracket, and a monitoring device mount. This platform architecture enables the host frame to operate as a specialized clinical utility vehicle, ensuring that critical therapy can be maintained without interruption while the user is in motion.

In an embodiment, the integrated medical-support platform further comprises a standardized latching interface configured to removably receive an adaptive postural seating module. This modularity allows the medical-support platform to be customized with various therapeutic seating implementations while maintaining a consistent load-transfer path through a structural seat arch. The infusion support structure within this platform may comprise a height-adjustable vertical pole configured to support a plurality of infusion containers, while the multi-tier storage rack is vertically aligned on the structural support members to optimize the lateral footprint for use in constrained clinical environments.

In an embodiment, the mechanical wheelchair includes specialized features for enhanced clinical utility and caregiver control. A wheel assembly is mounted to a lower portion of the collapsible frame and is specifically configured for both indoor and outdoor primary mobility, featuring at least two rear wheels and two front universal caster wheels. To ensure safe operation during caregiver-assisted propulsion, the frame incorporates a first and second U-shaped handle pivotally mounted to the first and second ends of the frame, respectively. These handles are independently rotatable and are configured to fold toward a central region of the frame to facilitate a compact footprint in the storage configuration.

In an embodiment, structural stability and refined rotational control are further achieved through the specific geometry of the seating and recline linkages. The joint bar pivotally coupling the seat pan to the rigid backrest includes an arc-shaped sliding slot configured to receive a sliding rod. This configuration ensures that movement of the sliding rod within the arc-shaped sliding slot guides a controlled rotational path of the seat pan relative to the rigid backrest while preserving continuous structural engagement with the rigid seat arch. This coordinated movement allows for recline adjustment without sacrificing the load-transfer integrity between the seat and the wheelchair frame.

To further support specialized pediatric and therapeutic needs, the invention includes a variety of integrated patient-engagement and life-support accessories. The frame integrates a user access gate movable between a closed position that restricts occupant egress and an open position that permits lateral entry, exit, or transfer, featuring a closure mechanism to releasably secure the gate.

The wheelchair may include a tabletop assembly comprising a movable activity tray coupled to the frame via a sliding limiting structure, allowing it to be selectively positioned between a storage position and a use position in front of the postural support seating system. For clinical safety, the flexible restraint assembly features a waist wrap pad with a cushioned layer specifically configured for pressure redistribution during extended therapeutic use. Additional integrated features include a synchronized rear brake assembly with a foot-actuated pedal linkage, and an infusion pole assembly including a vertical support member and a height adjustment mechanism.

Collectively, these elements provide a modular, system-level architecture that allows the mechanical wheelchair to operate as both a high-stability therapeutic seating system and a robust mobile medical-support platform. By anchoring the seating system through a defined seat arch and latching interface, the device ensures consistent load transfer and alignment that traditional pediatric transport tools cannot achieve.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the figures, and

FIG. 1 is a front perspective view of a mechanical wheelchair 100 illustrating a collapsible load-bearing frame formed by first upright poles 102 and second upright poles 104, opposed folding bars 106, 108 defining scissor-action side X-braces, a wheel assembly 112, pivotally mounted U-shaped push rods 110, and integrated medical-support interfaces including an infusion pole assembly 114, a medical equipment holder 116, a multi-tier storage rack 118, and a structural seat arch 120;

FIG. 2 is a rear perspective view of the mechanical wheelchair 100 showing the wheel assembly 112, U-shaped push rods 110, medical equipment holder 116, infusion pole assembly 114, rigid backrest 124, seat pan 126, plug posts 122, and the folding bars 106, 108;

FIG. 3 is a side elevation view focusing on the modular seat-to-frame interface, illustrating the mechanical wheelchair 100, the structural seat arch 120, latching hook assembly 130 including elastic hook arms 130a, plug post 122, inserting rod 136, groove 138, arc-shaped sliding slot 132, sliding rod 134, and the wheel assembly 112;

FIG. 4 is a front elevation view of the mechanical wheelchair 100 highlighting the first upright poles 102, U-shaped push rods 110, wheel assembly 112, medical equipment holder 116, infusion pole assembly 114, and rigid backrest 124;

FIG. 5 is a rear elevation view of the mechanical wheelchair 100 showing the rigid backrest 124 with harness adjustment slots, joint bars 128, folding bars 106, 108, and the wheel assembly 112;

FIG. 6 is a top plan view illustrating the mechanical wheelchair 100, seat pan 126, U-shaped push rods 110, wheel assembly 112, and medical equipment holder 116, depicting the lateral footprint of the collapsible frame;

FIG. 7 is a bottom plan view showing the mechanical wheelchair 100, structural seat arch 120, latching hook 130, inserting rod 136, groove 138, plug post 122, folding bars 106, 108, and wheel assembly 112;

FIG. 8 is a side elevation view emphasizing the controlled recline mechanism, illustrating the joint bar 128, arc-shaped sliding slot 132, sliding rod 134, rigid backrest 124, seat pan 126, and structural seat arch 120; and

FIG. 9 is an opposite side elevation view illustrating the mechanical wheelchair 100 configured as a mobile medical-support platform, showing the infusion pole assembly 114, medical equipment holder 116, multi-tier storage rack 118, user access gate 140, U-shaped push rods 110, and wheel assembly 112.

### DETAILED DESCRIPTION

The present invention relates generally to primary mobility devices and, more particularly, to a mechanical wheelchair 100 configured for manual or caregiver-assisted primary mobility and integrated clinical support for individuals with mobility impairment. The invention features a modular postural support seating system with a defined structural seat-to-frame interface and a controlled recline mechanism configured for therapeutic positioning.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

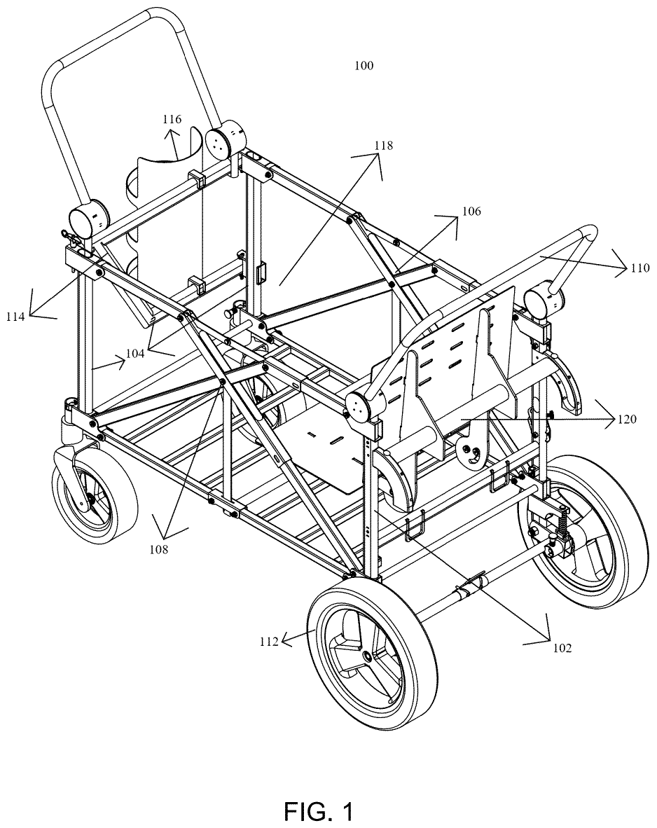

The mechanical wheelchair 100 designed for primary mobility and integrated medical support according to various embodiments of the present invention will now be described with reference to the accompanying drawings, particularly FIGS. 1-9. The device is specifically engineered to serve as a mobile medical-support platform capable of simultaneously providing patient mobility and integrated support for life-sustaining medical equipment.

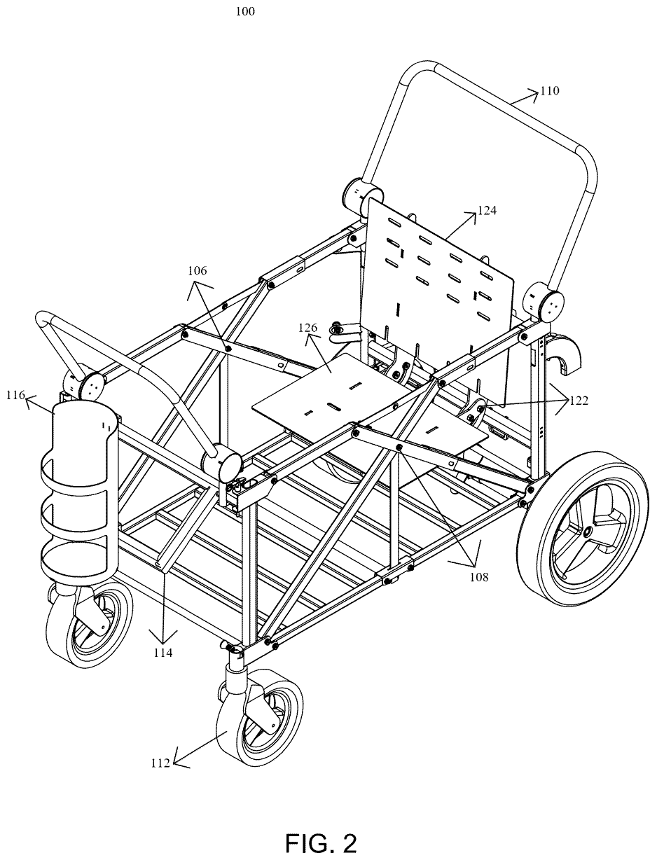

Referring to FIGS. 1-2, the mechanical wheelchair 100 comprises a collapsible, load-bearing frame formed by first upright poles 102 at a first end (front) and second upright poles 104 at a second end (rear). The frame is reinforced by opposed folding bars 106 and 108 defining scissor-action side X-braces. This architecture allows the collapsible frame to transition between an unfolded use configuration and a folded storage configuration. Caregiver-assisted propulsion is facilitated by U-shaped push rods 110 (handles) pivotally mounted to the frame, which may fold toward a central region for compact storage. Mobility is provided by a wheel assembly 112 featuring rear wheels and front universal caster wheels for precision maneuvering in both indoor and outdoor environments.

In an embodiment, a critical aspect of the frame's design is its integration with medical support structures. As shown in FIG. 1, the frame is not merely a transport vehicle but a clinical platform. It includes an infusion pole assembly 114 coupled to the rear structural members, featuring a vertical support member and a height adjustment mechanism to support intravenous (IV) or medical fluid equipment during patient transport. Additionally, a medical equipment holder 116 (or mounting interface) is secured to the frame, configured to support specialized devices such as an oxygen cylinder, respiratory equipment, a medical pump, or a physiological monitoring device, or other life-sustaining or therapeutic medical equipment. A multi-tier storage rack 118 is vertically aligned on the rear frame members to maximize supply carriage (e.g., tubing, bandages, personal items) while minimizing the lateral footprint of the wheelchair.

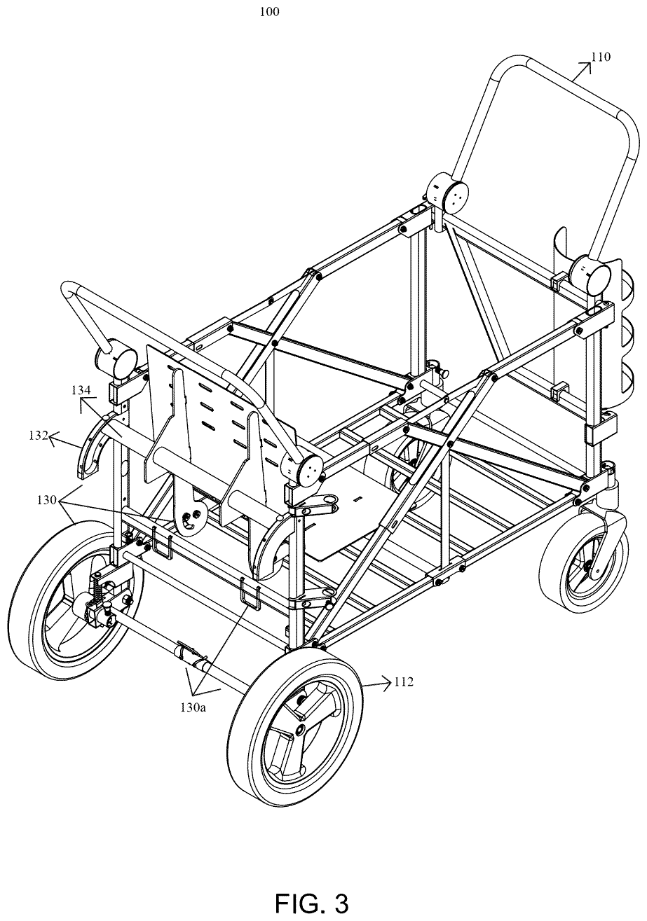

In an embodiment, referring to FIG. 3, the invention features a modular postural support seating system removably supported by the collapsible frame. This system comprises a rigid postural seat including a rigid backrest 124 and a seat pan 126. A defining feature of this embodiment is the rigid seat arch 120, a transverse structural beam positioned between the postural seat and the collapsible frame. This rigid seat arch 120 serves as a specialized load-bearing interface, transmitting user load from the seat directly into the structural support members of the frame (e.g., the X-braces 106, 108 and uprights 102, 104).

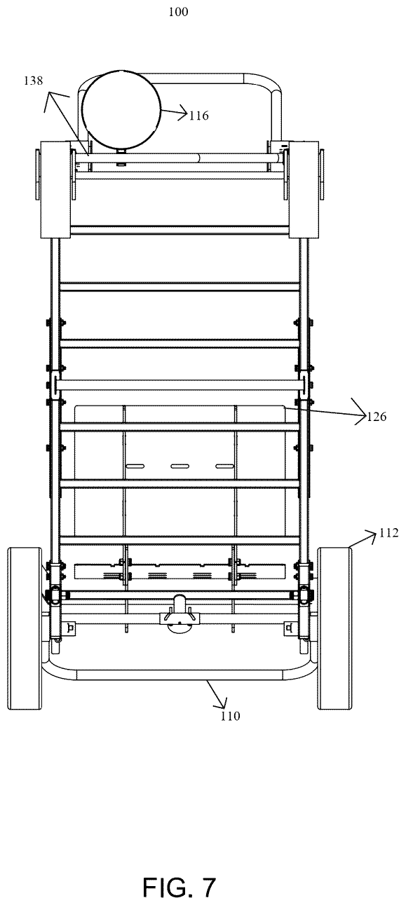

In an embodiment, as detailed in FIG. 3 and the bottom view of FIG. 7, secure attachment of the modular seat is achieved by at least one latching hook 130 coupled to the postural seat. The latching hook 130 is configured to selectively engage a corresponding receiving portion of the rigid seat arch 120. This hooked engagement resists vertical, lateral, and rotational displacement of the seat relative to the frame, effectively locking the seat in place for safe transport. To further stabilize the modular interface, the seat includes an inserting rod 136 extending downwardly or laterally, which docks into a corresponding plug post 122 on the frame. The inserting rod 136 features a locking groove 138 that mates with the plug post 122 to prevent rattle and ensure precise alignment. This combination of the rigid seat arch 120, latching hook 130, inserting rod 136, and plug post 122 defines a standardized modular docking interface, allowing for tool-free attachment and removal of the seating unit.

In an embodiment, the latching hook 130 comprises a resilient hook sub-assembly configured to provide automatic snap-fit engagement with the rigid seat arch 120. As shown in FIGS. 3 and 7, the latching hook 130 may be formed as a generally U-shaped or dual-arm elastic member mounted to a lower portion of the postural seat and extending toward the rigid seat arch 120. The latching hook 130 is configured such that, during downward docking of the postural seat, the hook arms elastically deform outwardly to pass over the rigid seat arch 120 and subsequently return inwardly to capture the rigid seat arch 120 in a retained position. The elastic hook arms 130a form part of the latching hook assembly 130 and define the resilient engagement structure configured to capture the rigid seat arch 120. The latching hook 130 may be formed of spring steel, resilient polymer, or any elastically deformable material capable of repeated snap engagement.

In this embodiment, the latching hook 130 functions as a self-locking mechanical latch that does not require manual actuation during installation. The inherent elastic bias of the latching hook 130 provides a restoring force that maintains continuous contact between the hook engagement surface and the rigid seat arch 120, thereby preventing unintended disengagement under vertical load, lateral forces, or vibrational movement during wheelchair operation.

In an embodiment, the latching hook 130 may further include a dual-wire or dual-rod configuration, wherein two parallel resilient arms define a capture cavity sized to receive the rigid seat arch 120. This configuration distributes load symmetrically across the seat-to-frame interface and reduces localized stress concentration. The geometry of the hook arms permits limited elastic deflection to accommodate manufacturing tolerances while maintaining rigid positional constraint once engaged.

In an embodiment, removal of the postural seat is achieved by manually deflecting the latching hook 130 away from the rigid seat arch 120, thereby releasing the hook engagement and allowing the seating module to be lifted from the collapsible frame. This provides a tool-free modular attachment system while preserving a structurally positive mechanical lock during use.

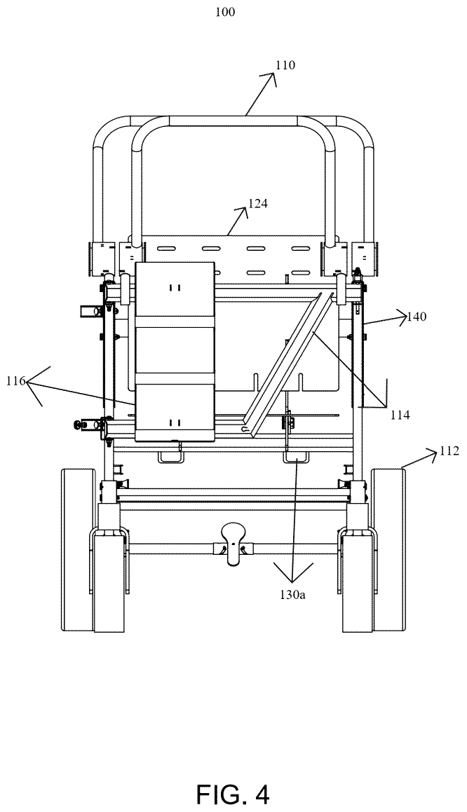

Referring to FIG. 4, a front elevation view of the mechanical wheelchair 100 is illustrated, detailing the lateral stability and integrated access features. The frame is defined by the first upright poles 102 which provide the primary forward structural support. A key improvement in this embodiment is the integration of a user access gate 140 into the side wall portion of the collapsible frame. As shown, the user access gate 140 is configured to move between a closed position, which restricts occupant egress during transport, and an open position that creates a clear lateral path for entry, exit, or patient transfer, the gate being operable by any suitable closure mechanism and not limited to any specific lock, latch, hinge, or hardware structure.

In an embodiment, the view further illustrates the infusion pole assembly 114 rising from the rear of the frame, positioned to provide gravity-fed therapy without obstructing the caregiver's line of sight. The medical equipment holder 116 is visibly mounted to the side structure, ensuring that critical devices like oxygen cylinders or monitoring pumps remain within the frame's lateral footprint to prevent snagging during mobility.

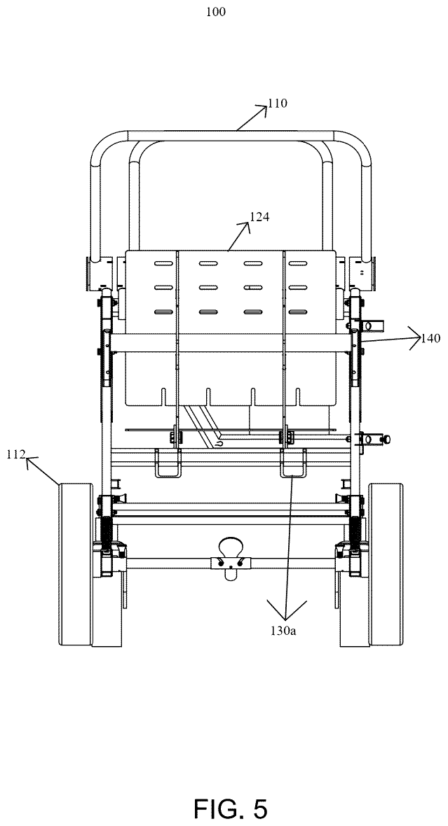

Referring to FIG. 5, a rear elevation view highlights the caregiver interface and postural support features. The rigid backrest 124 is shown featuring a plurality of horizontally aligned harness adjustment slots arranged in at least two vertical columns and four vertically spaced rows. These slots allow for the precise, incremental routing of a flexible restraint assembly to accommodate pediatric growth.

In an embodiment, the U-shaped push rods 110 are depicted in their deployed position for caregiver propulsion. From this rear angle, the user access gate 140 is visible in its secured, closed state, demonstrating how it forms a rigid structural barrier integrated with the second upright poles 104. The wheel assembly 112 provides a wide, stable base, supporting the vertical load of both the occupant and the loaded multi-tier storage rack 118 (not fully visible in this angle but structurally supported by the rear poles).

In an embodiment, the latching hook 130 comprises a resilient U-shaped latch member mounted to the rigid postural seat and configured to elastically engage an underside portion of the rigid seat arch 120. As shown in FIGS. 4, 5 and 7, the latching hook 130 includes a spring-biased arm portion configured to snap over the structural seat arch 120 during downward insertion of the seating module and to automatically return to a locked position once seated. This configuration provides a self-locking engagement that resists upward separation, vibration-induced loosening, and rotational movement of the postural seat relative to the collapsible frame while permitting manual release for tool-free removal. The latching hook 130 may be formed of spring steel, resilient polymer, or any elastically deformable material capable of repeated snap engagement.

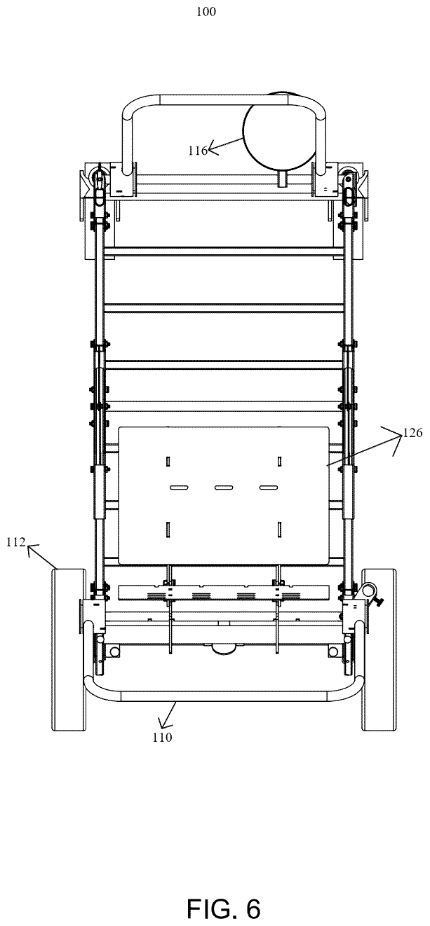

In an embodiment, FIG. 6 provides a top plan view of the mechanical wheelchair 100, illustrating the spatial arrangement of the modular postural seating system relative to the frame. The seat pan 126 is centrally positioned to optimize the center of gravity over the wheel assembly 112.

In an embodiment, crucially, this view shows the lateral positioning of the medical equipment holder 116, which is engineered to support an oxygen cylinder or respiratory device without interfering with the folding action of the U-shaped push rods 110. The footprint of the seat pan 126 is shown relative to the user access gate 140, confirming that when the gate is opened, there is sufficient clearance for a lateral transfer slide board or caregiver-assisted lift, a critical feature for users with limited mobility.

Referring now to FIG. 7 is a bottom plan view that reveals the core load-bearing architecture of the invention. This figure explicitly details the rigid seat arch 120, a transverse structural beam that runs beneath the seat pan 126. This rigid seat arch 120 acts as the primary load transfer member, transmitting the occupant's weight directly into the structural support members of the collapsible frame.

In an embodiment, the locking mechanism is clearly detailed here: at least one latching hook 130 is shown capturing the rigid seat arch 120 to prevent vertical separation. Simultaneously, the inserting rod 136 is shown docked into the frame's plug post 122, secured by a locking groove 138. This tripartite engagement (Arch-Hook, Rod-Post) creates a standardized modular docking interface that ensures the seat remains rigid and rattle-free during dynamic motion.

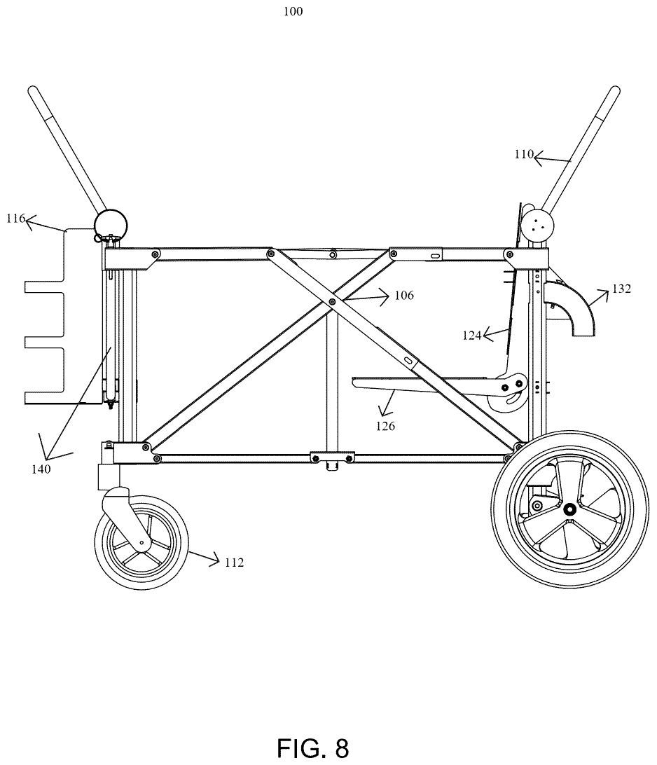

Referring to FIG. 8, a side elevation view details the controlled recline mechanism and its cooperation with the structural frame. A joint bar 128 pivotally couples the seat pan 126 to the rigid backrest 124. The recline path is defined by an arc-shaped sliding slot 132 housing a sliding rod 134.

In an embodiment, as the seat angle is adjusted, the sliding rod 134 moves within the arc-shaped sliding slot 132, guiding the seat's rotation. Importantly, this geometry ensures that the latching hook 130 remains continuously engaged with the rigid seat arch 120 throughout the recline range. This view also illustrates the rigid lateral trunk supports integrated into the backrest, which are configured as structural load-bearing elements to resist lateral trunk collapse, ensuring the user remains aligned even when the seat is tilted back.

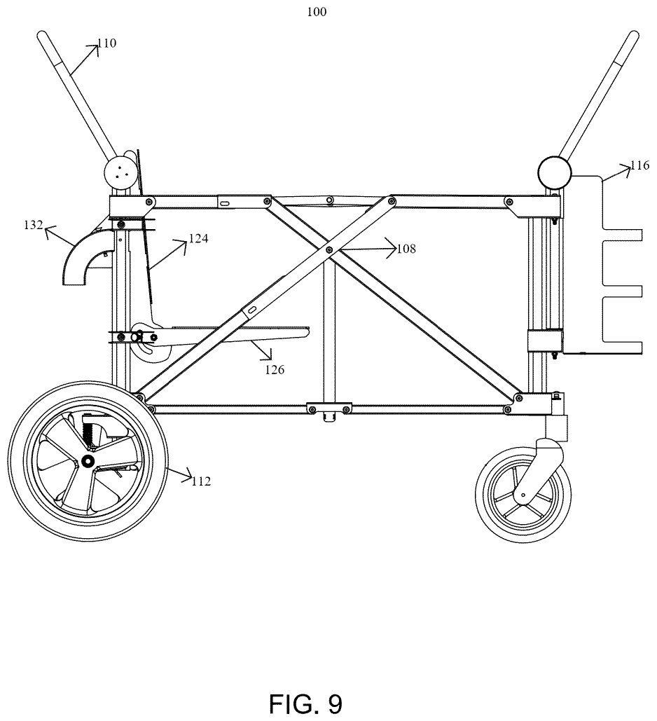

Referring to FIG. 9 illustrates the mechanical wheelchair 100 configured as a comprehensive mobile medical-support platform. The frame is shown supporting a height-adjustable infusion pole assembly 114, capable of holding IV bags or feeding pumps. The medical equipment holder 116 is mounted to the rear frame, sized to securely hold a portable oxygen supply or physiological monitor, or other therapeutic medical device.

In an embodiment, as the seat is reclined, the sliding rod 134 traverses the arc-shaped sliding slot 132, guiding the rotation of the seat pan 126 relative to the rigid backrest 124. Crucially, the geometry of this mechanism ensures that the latching hook 130 remains structurally engaged with the rigid seat arch 120 throughout the entire range of motion. This continuous engagement preserves the load transfer path from the occupant to the frame, ensuring stability and safety during both static seating and dynamic recline adjustments. The mechanism is designed to maintain pelvic and trunk alignment of the seated user, preventing sliding or shear forces commonly associated with standard recline systems.

In an embodiment, the versatility of the mechanical wheelchair 100 as a medical platform is further illustrated in FIG. 9. In addition to the infusion pole assembly 114 and medical equipment holder 116, the frame integrates a user access gate 140. As shown in FIG. 4 and FIG. 9, the user access gate 140 is integrated into a side wall portion of the collapsible frame. The gate is movable by any suitable mechanical arrangement between a closed position that restricts occupant egress and forms a rigid side barrier, and an open position that creates a clear lateral path for entry, exit, or patient transfer. A closure mechanism is provided to releasably secure the gate in the closed position during transport, the closure mechanism being of any form suitable to maintain the gate in the closed position without limiting the invention to a specific hardware design.

In an embodiment, the modular postural seating system is configured as a self-contained therapeutic unit capable of being selectively detached from and reattached to a compatible wheelchair frame. The rigid postural seat comprising the rigid backrest 124 and seat pan 126, together with the rigid seat arch 120 and latching hook 130, forms a standardized seating module that may be transferred between multiple wheelchair frames having corresponding structural interfaces.

In this embodiment, the rigid seat arch 120 defines a standardized load-bearing geometry such that any compatible seating module equipped with a corresponding latching hook 130 and inserting rod 136 may be removably secured to the frame without modification of the underlying structural support members. This configuration allows clinicians or caregivers to interchange seating systems based on therapeutic requirements while maintaining a consistent mechanical load-transfer path into the collapsible frame.

The modular seating system is therefore not limited to a single seating configuration, but may include alternative postural shells, pediatric growth-adaptive seats, pressure-relief cushions, or condition-specific therapeutic seating structures, all of which remain structurally compatible through the standardized rigid seat arch and latching interface.

In an embodiment, the mechanical wheelchair 100 functions as a mobile medical-support wheelchair platform in which the collapsible frame itself defines a distributed mounting architecture for life-sustaining clinical equipment. The structural support members of the frame act as integrated equipment carriers rather than passive transport components.

In this embodiment, the plurality of medical equipment support interfaces are spatially distributed across the frame such that oxygen holders, infusion supports, respiratory mounts, and monitoring devices may be simultaneously deployed without interfering with user mobility, caregiver access, or folding of the frame.

In an embodiment, the medical equipment support interfaces may be permanently integrated into the frame or may comprise modular mounting ports configured to receive standardized brackets, clamps, or attachment accessories, thereby enabling customization of the platform for different clinical workflows.

In an embodiment, collectively, the rigid seat arch 120, latching hook 130, controlled recline mechanism, and integrated medical equipment interfaces define a unified mechanical architecture in which seating, mobility, and therapy are structurally integrated into a single system.

Unlike conventional mobility devices in which seating and medical equipment are treated as add-on accessories, the present invention embeds both functions into the core load-bearing structure of the wheelchair frame, thereby ensuring continuous mechanical stability, controlled load transfer, and clinical usability during movement.

This system-level integration enables the mechanical wheelchair 100 to function not merely as a transport device, but as a mobile clinical workstation capable of supporting pediatric rehabilitation, long-duration therapy, and caregiver-assisted treatment in both institutional and home-care environments.

Although particular embodiments of the invention have been described in detail for purposes of illustration, various modifications, and enhancements may be made without departing from the spirit and scope of the invention.

What is claimed is:

1. A mechanical wheelchair serving as a primary mobility device for individuals with mobility impairment, comprising:
a collapsible, load-bearing frame having a first end, a second end, a plurality of structural support members, and opposed side X-braces, the collapsible frame being configured to transition between an unfolded use configuration and a folded storage configuration and to support caregiver-assisted propulsion;
a postural support seating system removably supported by the collapsible frame, the postural support seating system comprising:
a rigid postural seat including a rigid backrest and a seat pan;
a rigid seat arch positioned between the postural seat and the collapsible frame, the rigid seat arch defining a load-bearing seat-to-frame interface; and
a joint bar pivotally coupling the seat pan to the rigid backrest;
wherein the rigid seat arch is a structural load transfer member configured to transmit user load from the postural seat directly into the structural support members of the collapsible frame during both static seating and dynamic mobility, and
wherein at least one latching hook coupled to the postural seat and configured to selectively engage a corresponding receiving portion of the rigid seat arch, the latching hook resisting vertical, lateral, and rotational displacement of the postural seat relative to the collapsible frame while permitting tool-free attachment and removal of the postural seat as a modular seating unit;
a controlled recline mechanism operatively coupling the postural seat to the collapsible frame, the controlled recline mechanism permitting caregiver-adjustable angular positioning of the postural seat while maintaining continuous structural engagement between the latching hook and the rigid seat arch;
a flexible restraint assembly mounted to the rigid backrest and configured to provide therapeutic postural support and positioning to a user, including a pediatric user the restraint assembly being expressly not intended for motor vehicle crash restraint use,
wherein the rigid backrest comprises a plurality of horizontally aligned harness adjustment slots arranged in at least two vertical columns and at least four vertically spaced rows for incremental strap positioning; and
a multi-tier storage rack mounted to at least one of the structural support members of the collapsible frame and configured to support medical supplies or caregiver equipment during wheelchair mobility.

2. The mechanical wheelchair of claim 1, wherein the rigid seat arch maintains positional stability of the postural seat during recline while preserving continuous load transfer to the collapsible frame.

3. The mechanical wheelchair of claim 1, wherein the latching hook includes a hooked engagement surface configured to capture the rigid seat arch and prevent upward disengagement under user load.

4. The mechanical wheelchair of claim 1, wherein the latching hook permits selective removal of the postural seat without disassembly of the collapsible frame.

5. The mechanical wheelchair of claim 1, wherein the rigid seat arch and the latching hook together define a standardized modular docking interface for interchangeable adaptive seating modules.

6. The mechanical wheelchair of claim 1, wherein the controlled recline mechanism maintains pelvic and trunk alignment of the seated user throughout angular adjustment.

7. The mechanical wheelchair of claim 1, wherein the controlled recline mechanism cooperates with the rigid seat arch to maintain therapeutic postural positioning during recline.

8. The mechanical wheelchair of claim 1, wherein the postural seat further comprises rigid lateral trunk supports integrated with the rigid backrest and configured as structural load-bearing elements to resist lateral trunk collapse during recline and transport.

9. The mechanical wheelchair of claim 1, comprising a wheel assembly including at least two rear wheels and at least two front universal caster wheels configured for indoor and outdoor mobility.

10. The mechanical wheelchair of claim 1, further comprising a medical equipment holder or mounting interface coupled to the collapsible frame and configured to support at least one of an oxygen cylinder, respiratory equipment, a medical pump, or a physiological monitoring device.

11. The mechanical wheelchair of claim 1, wherein the controlled recline mechanism includes an arc-shaped sliding slot formed in the joint bar and a sliding rod operatively engaged with the arc-shaped sliding slot, wherein movement of the sliding rod within the arc-shaped sliding slot guides controlled rotation of the seat pan relative to the rigid backrest while preserving structural engagement with the rigid seat arch.

12. The mechanical wheelchair of claim 1, further comprising a first U-shaped handle pivotally mounted to the first end of the collapsible frame and a second U-shaped handle pivotally mounted to the second end of the collapsible frame, the handles being foldable toward a central region of the frame for storage.

13. The mechanical wheelchair of claim 1, further comprising a synchronized rear brake assembly including a foot-actuated pedal linkage operatively connected between rear wheels.

14. A modular postural seating system for a mechanical wheelchair, comprising:
a rigid postural seat including a rigid backrest and a seat pan;
a rigid seat arch configured to define a load-bearing seat-to-frame interface,
wherein at least one latching hook mounted to the rigid postural seat and configured to removably engage the rigid seat arch to structurally secure the rigid postural seat to a frame of a mobility device; and
a controlled recline mechanism configured to permit caregiver-adjustable angular positioning of the rigid postural seat while maintaining engagement between the latching hook and the rigid seat arch.

15. The modular postural seating system of claim 14, wherein the rigid seat arch transfers occupant load directly to the wheelchair frame during both recline and static seating, and the rigid postural seat includes integrated lateral trunk supports and harness adjustment apertures for pediatric postural positioning.

16. A mobile medical-support wheelchair platform, comprising:
a collapsible, load-bearing frame having a first end, a second end, and a plurality of structural support members configured to serve as a mobility device under caregiver-assisted propulsion;
a wheel assembly mounted to the collapsible frame and configured for indoor and outdoor mobility, the wheel assembly including at least two rear wheels and two front universal caster wheels;
a multi-tier storage rack mounted to at least one of the structural support members and configured to support medical supplies during transport; and
a plurality of integrated medical equipment support interfaces distributed across the structural support members, the medical equipment support interfaces comprising at least one of:
an oxygen cylinder holder configured to support a portable oxygen supply;
an infusion support structure configured to support intravenous or infusion therapy equipment;
a respiratory equipment mounting bracket configured to support respiratory devices; and
a monitoring device mount configured to support a physiological monitoring device,
wherein the mobile medical-support wheelchair platform is configured to simultaneously provide patient mobility and integrated support for medical equipment during transport.

17. The platform of claim 16, wherein the multi-tier storage rack is vertically aligned on one of the structural support members to minimize the lateral footprint of the platform during transport, and the platform further comprises a standardized latching interface configured to removably receive an adaptive postural seating module.

18. The mechanical wheelchair of claim 1, further comprising an infusion pole assembly coupled to the collapsible frame, the infusion pole assembly including a vertical support member and a height adjustment mechanism configured to support intravenous or medical fluid equipment during use.

19. The mechanical wheelchair of claim 1, further comprising a user access gate integrated into a wall portion of the collapsible frame, the gate being movable between a closed position that restricts occupant egress and an open position that permits lateral entry, exit, or transfer, wherein the gate includes a closure mechanism configured to releasably secure the gate in the closed position.

20. The mechanical wheelchair of claim 1, further comprising a tabletop assembly comprising a movable activity tray coupled to the collapsible frame via a sliding limiting structure, the tabletop assembly being selectively positionable between a storage position and a use position in front of the postural support seating system.
